(19) United States
(12) Patent Application Publication
(10) Pub. No.: US 2024/0094988 A1
(43) Pub. Date: Mar. 21, 2024

(54) METHOD AND APPARATUS WITH MULTI-BIT ACCUMULATION

(71) Applicant: SAMSUNG ELECTRONICS CO., LTD., Suwon-si (KR)

(72) Inventors: Dong-Jin CHANG, Suwon-si (KR); Sungmeen MYUNG, Suwon-si (KR); Jaehyuk LEE, Suwon-si (KR); Daekun YOON, Suwon-si (KR); Seok Ju YUN, Suwon-si (KR)

(73) Assignee: SAMSUNG ELECTRONICS CO., LTD., Suwon-si (KR)

(21) Appl. No.: 18/117,597

(22) Filed: Mar. 6, 2023

(30) Foreign Application Priority Data
Sep. 14, 2022 (KR) 10-2022-0115784

(51) Int. Cl. G06F 7/544; G06F 7/40

(52) U.S. Cl. CPC G06F 7/5443; G06F 7/405

(57) ABSTRACT

A multi-bit accumulator including a plurality of 1-bit Wallace trees configured to perform an add operation on single-bit input data, a plurality of tristate buffers configured to output a result of the add operation of the 1-bit Wallace trees, according to an enable signal, and a shift-adder configured to perform an accumulation operation on the result of the add operation of the plurality of 1-bit Wallace trees by a shift operation based on a clock signal.

### CROSS-REFERENCE TO RELATED APPLICATIONS

This application claims the benefit under 35 USC § 119(a) of Korean Patent Application No. 10-2022-0115784, filed on Sep. 14, 2022, in the Korean Intellectual Property Office, the entire disclosure of which is incorporated herein by reference for all purposes.

### BACKGROUND

### 1. Field

The following description relates to a method and apparatus with multi-bit accumulation.

### 2. Description of Related Art

A convolutional neural network (CNN), which is one type of a deep neural networks (DNN), is widely used in various applications, such as image and signal processing that mimics the human optic nerve, object recognition, computer vision, and the like. In some instances, the CNN may be configured to perform a multiplication and accumulation (MAC) operation that repeats the multiplication and addition using a large number of matrices.

When a CNN is executed by general-purpose processors, a large number of calculations that are performed may not be as complex as typical MAC operations where the dot product of two vectors is computed and sums of the values are accumulated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus includes a multi-bit accumulator including plurality of 1-bit Wallace trees each configured to perform an add operation on single-bit input data, a plurality of tristate buffers configured to output a result of the add operation of the plurality of 1-bit Wallace trees, according to an enable signal, and a shift-adder configured to perform an accumulation operation on the result of the add operation of the plurality of 1-bit Wallace trees by a shift operation based on a clock signal.

Each of the plurality of 1-bit Wallace trees includes adder arrays may include full adders, the full adders being used in a final operation stage among a plurality of operation stages for the add operation. The adder array may include first-type full adders in which a first tristate buffer of the plurality of tristate buffers is connected to a first sum among pieces of the single-bit input data and a second-type full adder in which a second tristate buffer of the plurality of tristate buffers is connected to a second sum, the second sum corresponding to an operation result of the final operation stage and to a carry operation result generated by corresponding to the first sum.

Each of the plurality of tristate buffers may be configured to output a high-impedance state responsive to the enable signal having a first logical value and output the result of the add operation of the plurality of 1-bit Wallace trees to the shift-adder responsive to the enable signal having a second logical value opposite to the first logical value.

The apparatus may also include a logic gate configured to perform a logical operation between signed data and a most significant bit (MSB) in a result of the accumulation operation of the shift-adder responsive to the multi-bit accumulator performing a signed operation on the single-bit input data.

The logic gate may include an XOR gate configured to perform an XOR operation between the MSB and the signed data.

The apparatus may also include a signal generator configured to generate the enable signal that enables the tristate buffer by inverting the clock signal.

The apparatus may also include an in memory computing (IMC) processor, the IMC includes a cross-bar structure, input circuitry to sequentially input multi-bit first values, output circuit to output a multi-bit operation result, a memory array, a binary gate array, and the multi-bit accumulator.

The plurality of 1-bit Wallace trees may be configured to operate according to an enable signal having a first logical value and the shift-adder may be configured to operate in accordance with an enable signal having a second logical value opposite to the first logical value.

The apparatus may also include an in memory computing (IMC) processor, the IMC processor including a cross-bar structure, input circuitry to sequentially input multi-bit first values, output circuit to output a multi-bit operation result, a memory array, a binary gate array, and the multi-bit accumulator.

In one general aspect, an apparatus including in-memory computing (IMC) processor includes an IMC device including a plurality of IMC macros having a plurality of columns in a cross bar structure, an input controller configured to sequentially input multi-bit first values to the IMC device bit by bit, and a post operation circuit configured to output a multi-bit operation result that integrates operation results of the plurality of IMC macros. Each of the IMC macros includes a memory array including a plurality of bit cells, each bit cell of the plurality of bit cells being configured to store a second value applied to each of the multi-bit first values, a binary gate array including operation a plurality of gates, each gate of the plurality of gates being configured to perform a single-bit multiplication and accumulation (MAC) operation between the multi-bit first values and the second value, and a multi-bit accumulator configured to perform a bit-wise operation on results of the single-bit MAC operation and to perform an accumulation operation on a result of the bit-wise operation corresponding to any one of the plurality of columns, through a shift operation based on a clock signal.

The apparatus may include a plurality of 1-bit Wallace trees, each 1-bit Wallace tree of the plurality of 1-bit Wallace trees being configured to perform the bit-wise operation on the results of the single-bit MAC operation, a plurality of tristate buffers, each tristate buffer of the plurality of tristate buffers being configured to output a result of the bit-wise operation of a respective one of the plurality of 1-bit Wallace trees, according to an enable signal, and a shift-adder configured to perform an accumulation operation on a result of an add operation of a respective one of the plurality of 1-bit Wallace trees corresponding to any one of the plurality of columns by a shift operation based on a clock signal.

Each 1-bit Wallace tree of the plurality of 1-bit Wallace trees may include an adder array including full adders used in a final operation stage among a plurality of operation stages for the add operation, wherein the adder array may include a plurality of first-type full adders in which a respective tristate buffer of the plurality of tri-state buffers is connected to the results of the single-bit MAC operation and a second-type full adder in which a respective tristate buffer of the plurality of tri-state buffers is connected to a sum corresponding to an operation result of the final operation stage and to a carry operation result generated by corresponding to the sum.

The plurality of tristate buffers may each be configured to output a high-impedance state responsive to the enable signal having a first logical value and output the result of the bit-wise operation of the plurality of 1-bit Wallace trees to the shift-adder responsive to the enable signal having a second logical value opposite to the first logical value.

The apparatus may also include a logic gate configured to perform a logical operation between signed data and a most significant bit (MSB) in a result of the accumulation operation of the shift-adder responsive to the multi-bit accumulator performing a signed operation on the signed data.

The logic gate may include an XOR gate configured to perform an XOR operation between the MSB and the signed data.

The apparatus may also include a signal generator configured to generate the enable signal by inverting the clock signal.

The plurality of 1-bit Wallace trees may be configured to operate responsive to the enable signal having a first logical value and the shift-adder may be configured to operate responsive to the enable signal having a second logical value opposite to the first logical value.

The apparatus may be one of a mobile device, a mobile computing device, a mobile phone, a smartphone, a personal digital assistant, a fixed location terminal, a tablet computer, a computer, a wearable device, a laptop computer, a server, a music player, a video player, an entertainment unit, a navigation device, a communication device, a global positioning system (GPS) device, a television, a tuner, an automobile, a vehicle part, an avionics system, a drone, a multicopter, and a medical device.

In one general aspect, a method includes receiving input data, the input data being single-bit data, performing an add operation of 1-bit units on the input data, outputting a result of the add operation of the 1-bit units, based on an enable signal, and outputting a multi-bit operation result corresponding to the input data by shifting and accumulating a result of the add operation of the 1-bit units.

The outputting of the result of the add operation of the 1-bit units may include outputting a high-impedance state responsive to the enable signal having a first logical value and outputting the result of the add operation of the 1-bit units to a shift-adder responsive to the enable signal having a second logical value opposite to the first logical value.

The method may also include performing a logic operation between signed data and a most significant bit (MSB) in the multi-bit operation result responsive to the multi-bit accumulator performing a signed operation on the input data.

Other features and aspects will be apparent from the following detailed description, the drawings, and the claims.

### BRIEF DESCRIPTION OF THE DRAWINGS

FIG. 1 illustrates an example of a multi-bit accumulator.

FIGS. 2A and 2B illustrate an example of an operation of a Wallace tree.

FIG. 3A illustrates an example of a structure of a multi-bit accumulator structure.

FIG. 3B illustrates an example of a timing of the multi-bit accumulator.

FIG. 4 illustrates an example of an operation of a tristate buffer.

FIG. 5 illustrates an example of a structure of a multi-bit accumulator capable of performing a signed operation.

FIG. 6 illustrates an example of a structure of a multi-bit accumulator including an adder array.

FIG. 7 illustrates an example of a circuit of an adder array.

FIG. 8 illustrates an example of a circuit of a first-type full adder and a second-type full adder included in an adder array.

FIG. 9 illustrates an example of a method of operating a multi-bit accumulator.

FIG. 10 illustrates an example of a relationship between operations performed in an in memory computing (IMC) macro and a neural network.

FIG. 11 illustrates an example of an IMC processor including a multi-bit accumulator.

FIG. 12 illustrates an example of a structure of an IMC processor.

FIG. 13 illustrates an example of an electronic system including an IMC processor.

Throughout the drawings and the detailed description, unless otherwise described or provided, the same or like drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

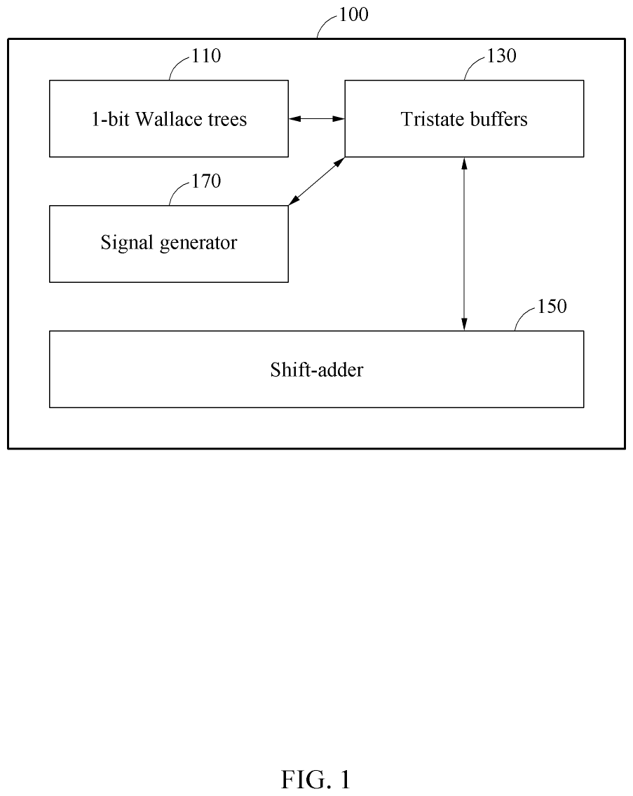

FIG. 1 illustrates an example of a multi-bit accumulator 100. Referring to FIG. 1, a multi-bit accumulator 100 according to an example may include 1-bit Wallace trees 110, tristate buffers 130, and a shift-adder 150. The multi-bit accumulator 100 may further include a signal generator 170.

The 1-bit Wallace trees 110 may perform an add operation on pieces of input data that contains a single-bit, e.g., single bit input data. A single bit may refer to 1 bit, containing only a zero or one value. Hereinafter, the terms ‘single bit’ and ‘1-bit’ may be understood to have the same meaning.

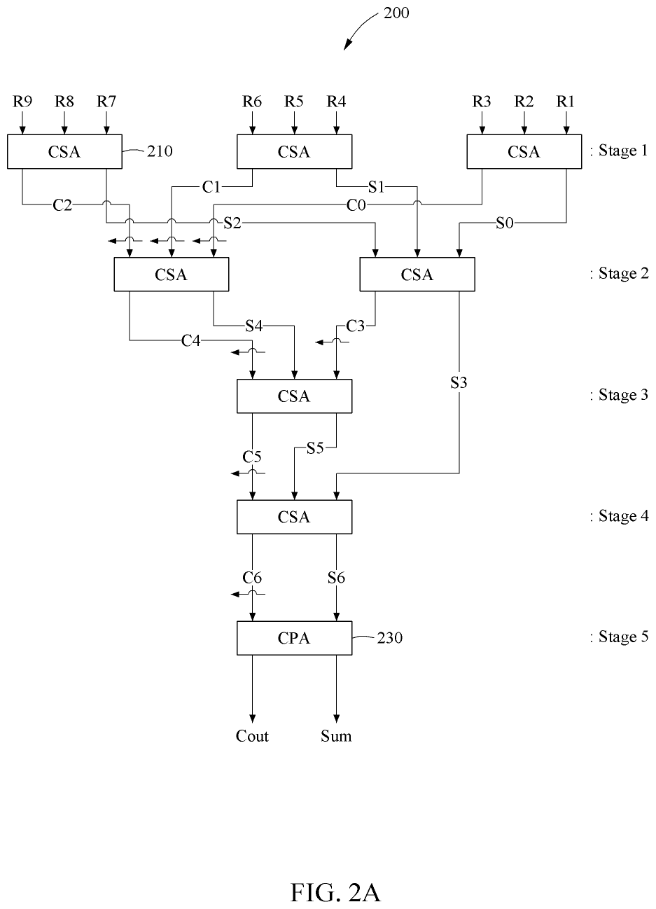

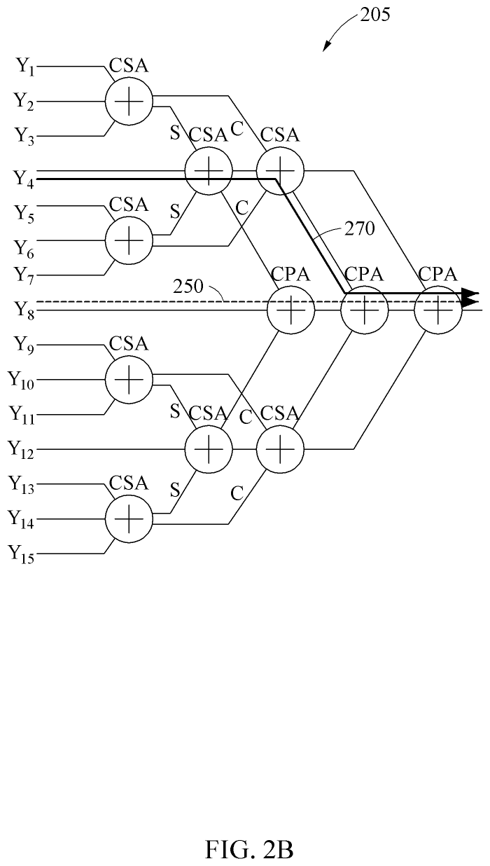

A method of operating the 1-bit Wallace trees 110 is described with reference to FIG. 2 below.

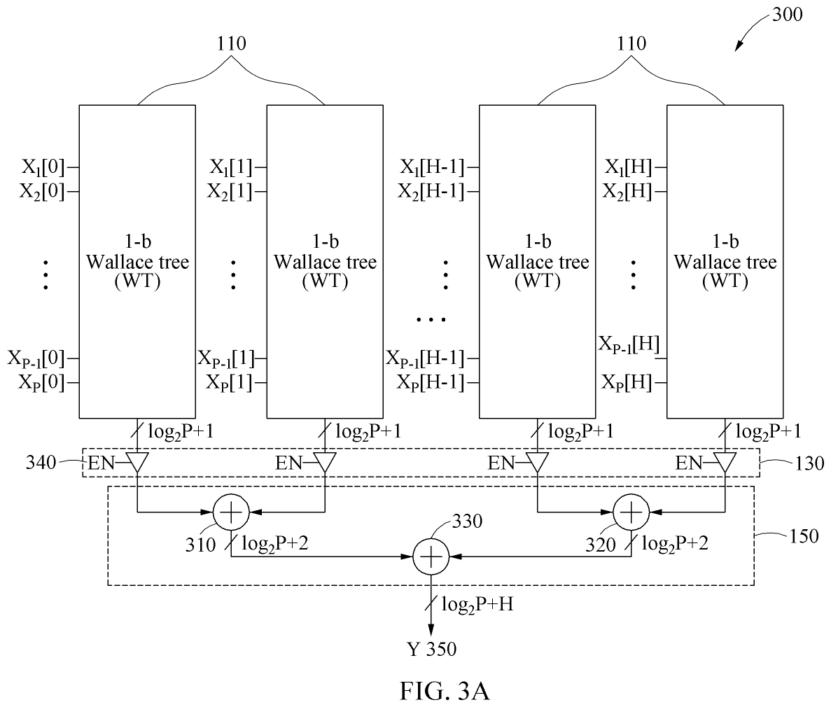

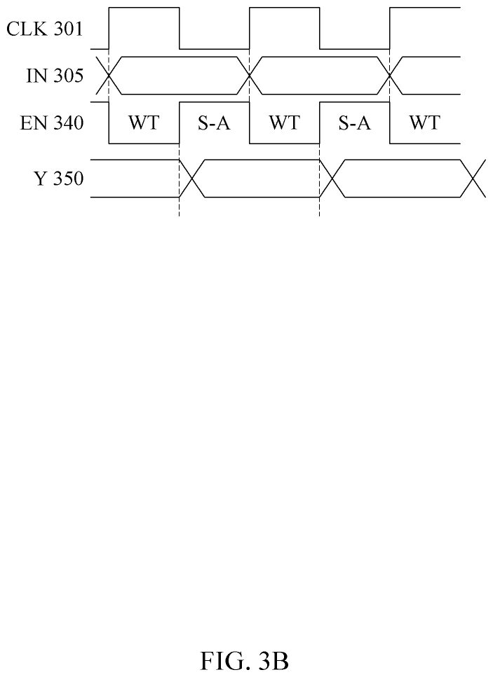

The structure and operation timing of the multi-bit accumulator 100 according to an example is described with reference to FIG. 3 below.

Referring to FIG. 1, the tristate buffers 130 may output an add operation result of the 1-bit Wallace trees 110 according to an enable (EN) signal generated by the signal generator 170. The tristate buffers 130 may, for example, output a high impedance state when the EN signal has a first logical value (e.g., a zero (0) value). Here, the ‘high impedance state’ may refer to a state where, at one point in a circuit, a relatively small amount of current per voltage unit that is applied to the point in the circuit passes. The numerical definition of ‘high impedance’ may vary depending on an application.

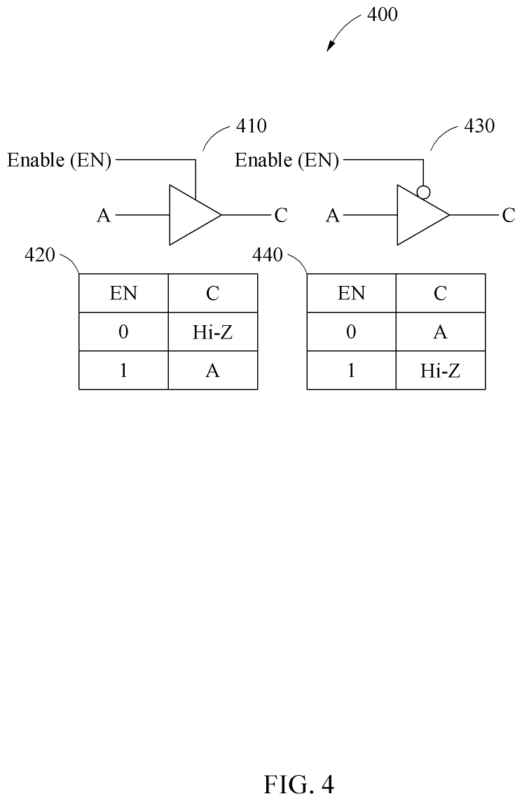

For example, when the EN signal has a second logical value (e.g., a one (1) value) opposite to the first logical value, the tristate buffers 130 may output the add operation result of the 1-bit Wallace trees 110 to the shift-adder 150. The method of operating the tristate buffer(s) 130 is described with reference to FIG. 4 below.

The 1-bit Wallace trees 110 may operate, in an example, in an instance in which the EN signal provides the first logical value (e.g., 0), and the shift-adder 150 may operate in another instance in which the EN signal provides a second logical value (e.g., 1) opposite to the first logical value.

The shift-adder 150 may perform an accumulation operation on the add operation result of the 1-bit Wallace trees 110 by a shift operation based on a clock signal. A relationship between the CLK signal and the EN signal is described with reference to FIG. 3B below.

For example, when the multi-bit accumulator 100 performs a signed operation on signed data, the multi-bit accumulator 100 may further include a logic gate that performs a logical operation between signed data and a most significant bit (MSB) among accumulation operation results of the shift-adder 150. The logic gate may include, for example, an XOR gate that performs an XOR operation (or a multiplication operation) between the signed data and the MSB among the accumulation operation results of the shift-adder 150.

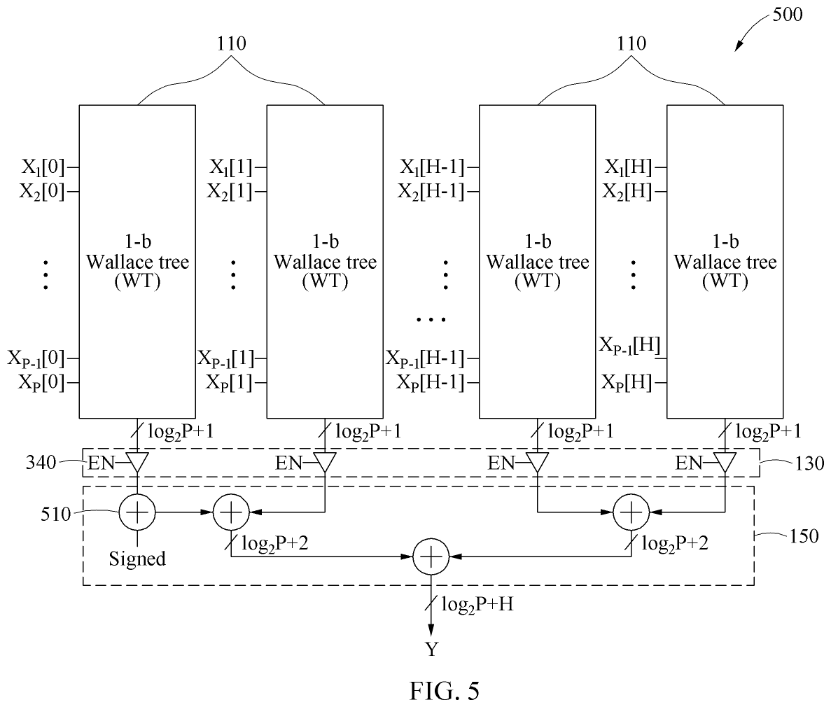

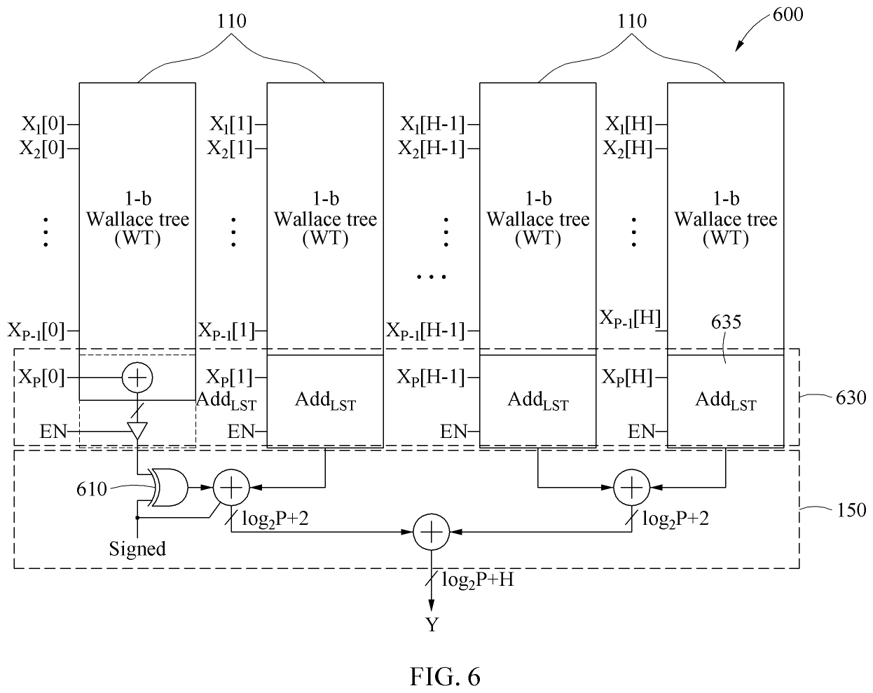

The structure and operation of the multi-bit accumulator 100 for performing a signed operation on signed data is described with reference to FIGS. 5 and 6 below.

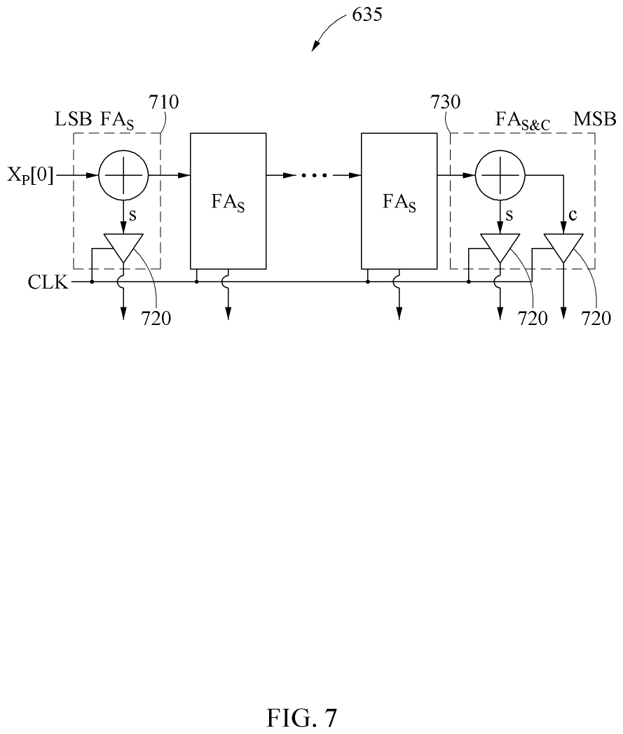

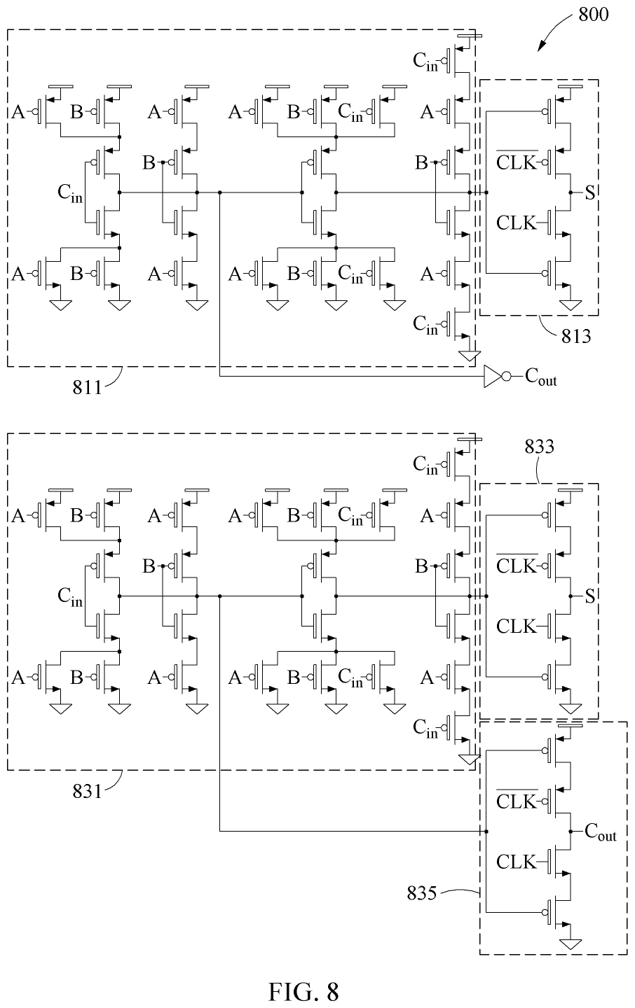

Each of the 1-bit Wallace trees 110 may include adder arrays including full adders used in a plurality of operation stages for an add operation (e.g., an adder array 630 of FIG. 6). An adder array may, for example, include first-type full adders (e.g., a full adder 710 of FIG. 8), in which a tristate buffer (refer to a tristate buffer 813 of FIG. 8) connects to a sum S of pieces of 1-bit input data, and a second-type full adder (e.g., a full adder 730 of FIG. 8), in which a tristate buffer (e.g., a tristate buffer 833 and a tristate buffer 835 of FIG. 8) connects to a sum S corresponding to an operation result of a final operation stage among a plurality of operation stages and to a carry operation result C generated according to the add operation. The structure and circuit of the adder array is described later with reference to FIGS. 7 and 8 below.

In one example, the signal generator 170 may generate an EN signal for enabling the tristate buffers 130 by inverting a CLK signal. Non-limiting circuit examples of various embodiments are demonstrated below with respect to at least FIGS. 2A-3A, 4-8, and 10-12.

FIGS. 2A and 2B illustrate an example of an operation of a Wallace tree.

Referring to FIG. 2A, an example of a structure of a Wallace Tree Adder (WTA) 200 is illustrated, the WTA 200 including one carry propagation adder (CPA) 230 and seven carry save adders (CSA) 210 for performing an operation among nine operands R1, R2, R3, R4, R5, R6, R7, R8, and R9.

The CSA 210 may correspond to a full adder configured to store a carry digit according to an operation result, that is, a carry. The CPA 230 may correspond to a full adder that propagates a carry.

The WTA 200 may correspond to a circuit configured to facilitate an operation of an arbitrary bit number by combining several full adders. The WTA 200 may configure each bit with a full adder and use the second digit of a previous digit of the full adder as a carry digit of a next digit, that is, as a carry. This may correspond to the same operation as performing calculations for each digit and rounding up each digit during addition. The WTA 200 may enable a high-speed operation by performing a partial sum among operands. In the example illustrated in FIG. 2A, the WTA 200 may each receive three pieces of input data at each CSA 210 of a first stage (e.g., Stage 1) for the partial sum among operands where each group may generate a value containing the sum of their respective input data. When the number of pieces of the input data is less than three, the WTA 200 may transfer the pieces of the input data to a next stage so that the partial sum may be performed in the next stage. When there are two of a sum S and a carry C left in a result of the partial sum, the WTA 200 may, for example, cause the add operation of a final operation stage to be performed by the CPA 230, which operates in a similar manner as that of a ripple carry adder.

In the second operation stage (e.g., Stage 2), the full adder 200 may calculate a single-digit binary number including a lower carry input (e.g., Carry in Ci). The full adder 200 may include, for example, two half adders and one OR operation. The full adder 200 may add a total of three bits including one 1-bit carry input Ci and two 1-bit operands so that a sum S and a carry output Co may be output. The full adder 200 may perform n-digit binary addition since the full adder 200 performs a calculation including a lower carry.

The logical formula of the full adder 200 may be expressed as Equation 1 below.

Co=A·B+Ci(A⊕B),Sum=A⊕B⊕Ci Equation 1:

Here, A and B may denote 2-bit operands and Ci may denote a carry input. Co may denote a carry output and Sum may denote a binary addition result.

When a sum operation is performed on nine operands as shown in FIG. 2A, for example, a carry output Cout and a final addition result Sum may be output through five operation stages from stage 1 to stage 5. Here, the ‘operation stage’ or the ‘stage’ may correspond to an operation stage performed through one full adder.

Referring to FIG. 2B, a diagram 205 is illustrated showing the structure of a 1-bit-based Wallace tree (1-bit WT) that performs an add operation on fifteen operands. The symbol [symbol] shown in FIG. 2B may represent a full adder.

The 1-bitWT may implement an adder using a small number of full adders. However, a path delay may occur and vary depending on the input data. For example, data Y4 may output a carry C and a final addition result S through four full adders, such as an input path 270. In addition, data Y8 may output its C and the S through three full adders, such as an input path 250. As such, in the case of using the 1-bit-WT, a toggle phenomenon may occur where an output changes from 0 to 1 or from 1 to 0 whenever a new input is applied. The toggle phenomenon occurs because a path delay can vary depending on an input path for that input. As a result, excess power may be consumed as a result of the toggle phenomenon occurring at the output.

However, is some examples, the use of the tristate buffer may prevent occurrence of the toggle phenomenon caused by the path delay, where the path delay changes for each input path when the 1-bit WT is used.

FIG. 3A illustrates an example of a structure of a multi-bit accumulator structure and FIG. 3B illustrates an example of a timing of the multi-bit accumulator. Referring to FIG. 3A, an example of a structure of a multi-bit accumulator 300 is illustrated.

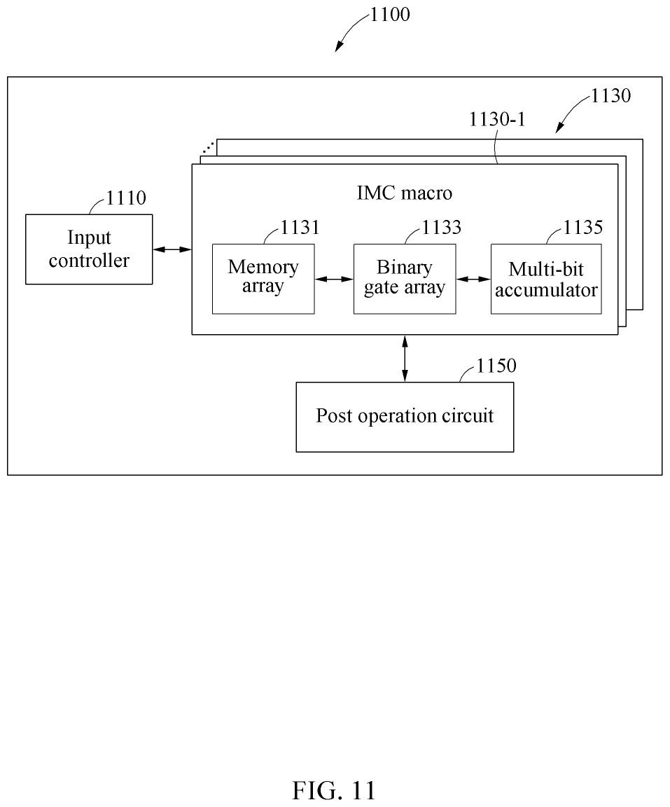

The multi-bit accumulator 300 may include, for example, one or more 1-bit Wallace trees 110, or 1-bit WT's, included in a plurality of in memory computing (IMC) macros (e.g., a plurality of IMC macros 1130-1 of FIG. 11) including a plurality of columns in a cross-bar structure. In this case, the plurality of IMC macros including columns in a cross-bar structure may perform, for example, a vector matrix multiplication operation and generally perform a multiplication and accumulation (MAC) operation. Each of the columns may include, for example, P bit cells that are B₁ to B_{P}, and the MAC operation may be performed by the P bit cells of each column. For example, a multiplication operation may be performed in units of each bit cell together with an input, and an accumulation operation may be performed in units of columns. Each of the 1-bit WT's 110 may correspond to each of the columns.

In the IMC macro, an operation on multi-bit input data and a weight may be performed, for example, in a manner that an H-bit weight and 1-bit input data may be multiplied and then H-bit S_{N} [H:1] corresponding to a result of the multiplication may be added by the multi-bit accumulator 300. Such an operation on the H-bit input data and the H-bit weight may be performed H times by changing a bit position of the input data and then be completed.

For example, when the multi-bit accumulator 300 performs an add operation on a 4-bit multiplication result of the H-bit weight and the 1-bit input data, 4-bit input data may be input to the multi-bit accumulator 300. Therefore, the multi-bit accumulator 300 may be configured in a manner where an adder in an add stage 1 may use 4 bits (e.g., 3 full adders+1 half adder) and use 5 bits (e.g., 4 full adders+1 half adder) to add outputs of an adder.

In addition, a signed operation on signed data may use a sign extension to process the signed data which may result in the use of one more full adder for the signed operation since there is a 1 bit increase in each stage to process overflows. Here, the ‘sign extension’ may correspond to an operation of increasing the number of bits of a binary number while maintaining a sign and a value of the number in the operation process. The sign extension may be used, for example, when a signed number is extended and may be performed by including an MSB value in the extended bit. When this additional full adder is used for the sign extension, the amount of full adders being employed may consume a large area, which may also increase the area of the IMC macro. Accordingly, in an example, the multi-bit accumulator 300 based on the 1-bit WT may improve an area efficiency of an adder tree in the IMC macro.

Since each of the 1-bit WT's 110 may apply input data to a carry-in port of a full adder, a small number of full adders may be used to perform an accumulation operation on a large amount of the input data. However, the 1-bit WT's 110 may have a different logic depth for each input data, so that the unnecessary output toggling as described above may occur. In order to prevent this unnecessary toggling from occurring, in an example, in the adder array, the full adder that generates the final output of the Wallace tree, that is, the operation result of the final operation stage, may connect the tristate buffers 130 to the Sum and Carry out. The multi-bit accumulator 300 may prevent the unnecessary output toggling by enabling the tristate buffers 130 to output an operation result or a high impedance state according to an EN signal 340.

The multi-bit accumulator 300 may correspond to, for example, an adder tree, but is not limited thereto.

The multi-bit accumulator 300 may include the 1-bit WT's 110 for performing an add operation first on P pieces of 1-bit input data X₁ to X_{P}. Here, the tristate buffers 130, which output the add operation result of the 1-bit WT's 110, may be added to adders in the final operation stage of the WT's 110, according to the EN signal 340.

The shift-adder 150 may output Y 350 that is a result of performing a shift operation and an add operation on outputs of the tristate buffers 130. The shift-adder 150 may include, for example, a full adder 310, a full adder 320, and a full adder 330, wherein the full adder 310 performs a first add operation on outputs of the tristate buffers 130 connected to two 1-bit WT's corresponding to a first column and a second column among the total four 1-bit WT's 110, the full adder 320 performs a second add operation on outputs of the tristate buffers 130 connected to two 1-bit WT's corresponding to a third column and a fourth column, and the full adder 330 performs an add operation of the first add operation and the second add operation. The operation result of the full adder 310 and the operation result of the full adder 320 may each correspond to a log 2 P+2 bit, and the operation result Y 350 of the full adder 330 may correspond to a log 2 P+H bit.

In this case, a shift operation on outputs of the tristate buffers 130 may be performed by the full adder 310 and the full adder 330. For example, it is assumed that an add operation is performed between A 4b of the full adder 310 and B 4b of the full adder 330. Here, when no shift operation is performed, when A3 (MSB), A2, A1, and A0 (Least Significant Bit (LSB)) are added to B3 (MSB), B2, B1, and B0 (LSB), A0 may be added to B0 first and a carry generated at this time may be added together when A1 is added to B1.

An add operation process when no shift operation is performed may be represented by signs as follows:
(A0+B0): Sum S 0, Carry C 0 generation
(A1+B1)+C0: S1, C1 generation
(A2+B2)+C1: S2, C2 generation
(A3+B3)+C2: S3 generation

Contrary to this, an add operation process when the shift operation is performed (e.g., when A is shifted by 1-bit than B) may be expressed by signs as follows:
B0: S0 generation
(A0+B1): S1, C1 generation
(A2+B2)+C1: S2, C2 generation
(A1+B3)+C2: S3, C3 generation
(A2)+C3: S4 generation

The multi-bit accumulator 300 may perform an accumulation operation on multi-bit input data through the structure shown in FIG. 3A.

Referring to 3B, an example of a timing diagram among a CLK signal 301, an IN signal 305, an EN signal 340, and an output Y 350 of the multi-bit accumulator 300 is illustrated.

The CLK signal 301 may correspond to a frequency of a system clock. The CLK signal 301 may, for example, branch four times at a maximum of 700 Mhz, but is not limited thereto. The CLK signal 301 may be generated, for example, as many as the number corresponding to a multiple (e.g., 1.5 times) of the number N of memory arrays including bit cells.

The IN signal 305 may correspond to a 1-cycle enable signal of the CLK signal 301.

The EN signal 340 may enable the tristate buffer(s) 130. A signal generator (e.g., the signal generator 170 of FIG. 1) may invert the CLK signal 301 to generate the EN signal 340.

The multi-bit accumulator 300 may cause the Wallace tree (WT) 110 to operate, when the EN signal 340 is equal to ‘0’ as shown in FIG. 3B, and the multi-bit accumulator 300 may cause the shift-adder 150, which is represented as S-A, to operate, when the EN signal 340 is equal to ‘1’.

In addition, when the EN signal 340 is equal to ‘1’, outputs of the tristate buffers 130 may be transferred to the shift-adder 150. In this case, outputs of the tristate buffers 130, which are routed in an actual chip, may generate a parasitic capacitance including an input capacitance of the shift-adder 150. In this case, data may be stored in the generated parasitic capacitance so that the shift-adder 150 may perform a pipeline operation. The multi-bit accumulator 300 may reduce the number of full adders corresponding to various pieces (e.g., P number of pieces) of 4-bit input data for signed data, which is described below, through a pipeline operation of the shift-adder 150 and may, at the same time, improve speed with the pipeline operation.

FIG. 4 illustrates an example of an operation of a tristate buffer. Referring to FIG. 4, a diagram 400 for explaining an operation of tristate buffer(s) 130 is illustrated. A diagram 410 may illustrate an operation in which an enable signal EN is applied to the tristate buffer(s) 130. A diagram 430 may illustrate an operation in which an an enable signal EN is applied to the tristate buffers 130.

For example, as shown in the table 420 associated with diagram 410, when the enable signal EN of ‘0’ is applied to the tristate buffer 130, the tristate buffer 130 may output a high-impedance state Hi-Z, regardless of the value of input data. Alternatively, in the case of the enable signal EN of ‘1’, table 420 shows that the tristate buffer 130 may output the value of input data A as it is (e.g., outputting an “A”).

Alternatively, as shown in table 440, related to the diagram 430, when the an enable signal EN of ‘0’ is applied to the tristate buffer 130 of diagram 430, the tristate buffer 130 may output the value of input data A. Alternatively, in the case of the an enable signal EN of ‘1’, the tristate buffer 130 may output the high-impedance state Hi-Z, regardless of the value of the input data A.

To summarize, when the enable EN signal has a second logical value (e.g., 1) opposite to a first logical value, the tristate buffers 130 may output an add operation result of 1-bit WT's to the shift-adder and, when the enable EN signal has the first logical value (e.g., 0), the tristate buffers 130 may output a high impedance state so that a previous add operation result is maintained until all of add operation results of the 1-bit WT's 110 arrive, thus preventing occurrence of the output toggling.

FIG. 5 illustrates an example of a structure of a multi-bit accumulator capable of performing a signed operation. Referring to FIG. 5, an example of a structure of a multi-bit accumulator 500 capable of performing a signed operation is illustrated. Since the structure of the multi-bit accumulator 500 is similar to the structure of the multi-bit accumulator 300 described above, hereinafter, a description of components that are redundant with the multi-bit accumulator 300 may be omitted.

For example, the multi-bit accumulator 500 may perform a signed operation on signed data. In this case, the multi-bit accumulator 500 may further include a logic gate 510 that performs a logical operation between the signed data and an MSB among accumulation operation results of a shift-adder 150. The logic gate 510 may be, for example, an XOR gate that performs an XOR operation between the MSB and the signed data as shown in FIG. 6, but is not limited thereto.

In an example, the logic gate 510 may perform an XOR logic operation on an MSB part among accumulation operation results of the shift-adder 150 so as to perform a signed operation and may reduce the number of full adders used for the signed operation.

FIG. 6 illustrates an example of a structure of a multi-bit accumulator including an adder array. Referring to FIG. 6, a structure of a multi-bit accumulator 600 including an adder array 630 is illustrated.

The multi-bit accumulator 600 may include one or more adder arrays 630 that include full adders used in a final operation stage among a plurality of operation stages for an add operation in each of the 1-bit WT's 110. The tristate buffers 130 described above may be embedded for an individual adder Add_{LST} 635 of the adder array 630.

For a complement operation on two in the multi-bit accumulator 600, a negative operation on the signed data of the MSB corresponding to the final operation stage may be implemented by an XOR gate 610. The structure and circuit of the Add_{LST} 635 is described later with reference to FIGS. 7 and 8 below.

FIG. 7 illustrates an example of a circuit of an adder array and FIG. 8 illustrates an example of a circuit of a first-type full adder and a second-type full adder included in an adder array.

Referring to FIG. 7, an example of an individual adder Add LST 635 from adder arrays 630 of FIG. 6 is illustrated. In addition, referring to FIG. 8, a circuit diagram 800 is illustrated where a first-type full adder FA_{S} 710 and a second-type full adder FAS&C 730 are included in an individual adder Add_{LST} 635.

The individual adder Add_{LST} 635 included in the adder arrays 630 may include the first-type full adder FA_{S} 710, when a tristate buffer 720 connects to an add operation result S among pieces of 1-bit input data, and the second-type full adder FAS&C 730, when the tristate buffer 720 connects to each of a sum S corresponding to an operation result of a final operation stage and a carry operation result C generated corresponding to the operation result of the final operation stage.

The individual adder Add_{LST} 635 may be, for example, a circuit in which the tristate buffer 720 is added to outputs of the full adder FA in the form of a log 2P-bit ripple carry adder. For example, when the full adders and the tristate buffer 720 are separately designed and attached to each other, the number of used transistors may increase. In an example, as illustrated in FIG. 8, the tristate buffer 720 may be included in the individual adder Add_{LST} 635 without a loss of a large area by adding, to a full adder (e.g., a full adder 811 or a full adder 831) as shown in FIG. 8, tristate buffers 813, 833, and 835 including two transistors or four transistors.

Referring to FIG. 8, first-type full adders FA_{S} 710 may have a form in which the tristate buffer 813 connects to an add operation result S among pieces of single-bit input data by the full adder 811. The second-type full adder FA_{S&C} 730 may have a form in which the tristate buffer 833 connects to a sum S corresponding to the operation result of the full adder 831 of the final operation stage and the tristate buffer 835 connects to a carry operation result C generated by corresponding to the addition operation result S of the full adder 831. The second-type full adder FA_{S&C} 730 may output the operation result of the MSB of the final operation stage.

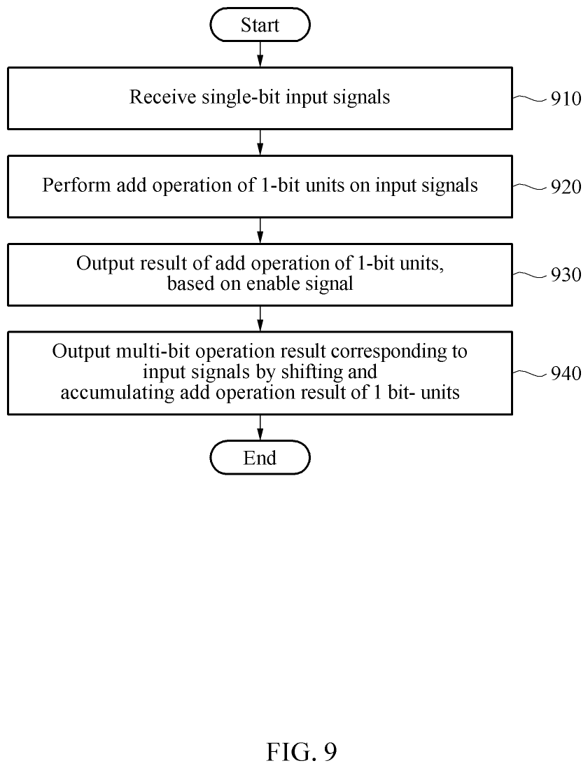

FIG. 9 illustrates an example of a method of operating a multi-bit accumulator. In the following examples, operations may be performed sequentially, but not necessarily performed sequentially. For example, the order of the operations may change and at least two of the operations may be performed in parallel.

Referring to FIG. 9, a multi-bit accumulator (e.g., the multi-bit accumulator 100 of FIG. 1) according to an example may include a multi-bit operation result corresponding to single-bit input signals through operations 910 to 940.

In operation 910, the multi-bit accumulator may receive pieces of the single-bit input data.

In operation 920, the multi-bit accumulator may perform an add operation on the pieces of input data of 1-bit units received in operation 910.

In operation 930, the multi-bit accumulator may output a result of the add operation of 1-bit units in operation 920, based on an enable signal. For example, when the enable signal has a first logical value (e.g., 0), the multi-bit accumulator may output a high-impedance state. When the enable signal has a second logical value (e.g., 1) opposite to the first logical value, the multi-bit accumulator may output an add operation result of 1-bit WT's to a shift-adder.

In operation 940, the multi-bit accumulator may output a multi-bit operation result corresponding to the pieces of input data by shifting and accumulating the add operation result in 1-bit units, output in operation 930.

For example, when the multi-bit accumulator performs a signed operation on signed data, the multi-bit accumulator may perform a logical operation (e.g., an XOR logical operation) between the signed data and an MSB in the multi-bit operation result.

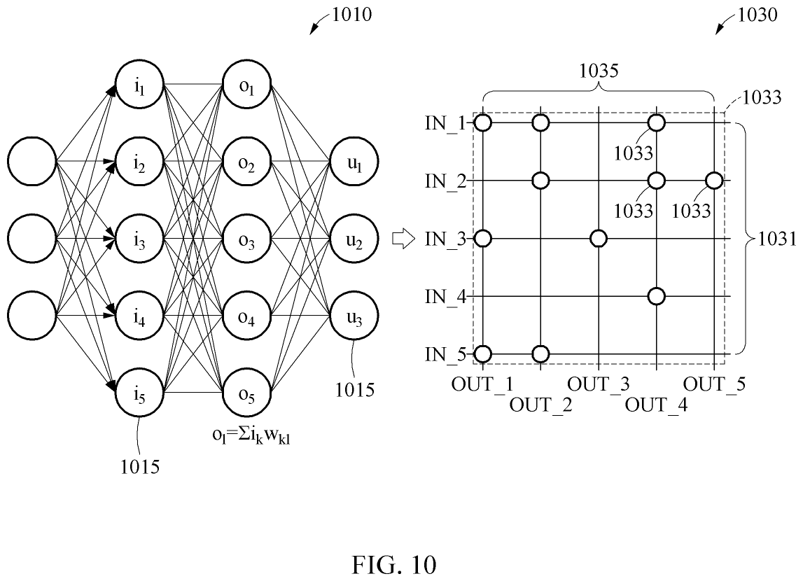

FIG. 10 illustrates an example of a relationship between operations performed in an in memory computing (IMC) macro and a neural network. Referring to FIG. 10, a neural network 1010 and a memory array 1030 of an IMC circuit corresponding to the neural network 1010 are illustrated.

The IMC may correspond to a computing architecture that allows an operation to be performed directly inside a memory in which data is stored to break through performance and power limitations caused by frequent data movement between the memory and arithmetic units (e.g., processors) that occur in von-Neumann architectures. An IMC macro may be divided into an analog IMC macro and a digital IMC macro according to which domain an operation is to be performed. The analog IMC macro may, for example, perform an operation in an analog domain, such as current, electric charge, time, and the like. The digital IMC macro may use a logic circuit to perform an operation in a digital domain.

The IMC macro may accelerate a matrix operation and/or an MAC operation that performs addition of multiple multiplications at a time for artificial intelligence (AI) learning-inference. Here, the MAC operations for the neural network 1010 may be performed through the memory array 1030 including bit cells of a memory device in the IMC macro.

The IMC macro may enable machine learning of the neural network 1010 by performing the MAC operations via operation functions by the memory array 1030 including the bit cells and operators added to the memory array 1030.

The neural network 1010 may be, for example, a deep neural network (DNN) including two or more hidden layers or an n-layer neural network. The neural network 1010 may be, for example, a DNN including an input layer (Layer 1), two hidden layers (Layer 2 and Layer 3), and an output layer (Layer 4), but is not limited thereto. For example, when the neural network 1010 is implemented in a DNN architecture, the neural network 1010 may include a greater number of layers that may process valid information and may thus process more complex data sets than a neural network having a single layer. Although the neural network 1010 is illustrated as including three layers, this is only an example, and the neural network 1010 may include fewer or more layers or channels. That is, the neural network 1010 may include layers of various structures different from one illustrated in FIG. 10.

Each of the layers included in the neural network 1010 may include a plurality of nodes 1015. A node may correspond to a plurality of processing elements (PEs), as hardware processing circuitry, for example, and respective nodes may also be referred to as respective channels for example. The neural network 1010 may include, for example, an input layer including three nodes, hidden layers respectively including five nodes, and an output layer including one node, but is not limited thereto. Thus, FIG. 10 is only an example, and each of the layers included in the neural network 1010 may include various numbers of nodes. The nodes 1015 included in each of the layers of the neural network 1010 may be connected to one another to process data. For example, one node may receive data from other nodes to perform an operation and may output a result of the operation to other nodes.

A plurality of nodes 1015 may be connected to nodes of another layer through a connection line, and a weight w may be set for the connection line. For example, an output o1 of one node may be determined based on input values (e.g., i1, i2 and i3) propagated from other nodes of a previous layer connected to the node, and on weights w11, w21, w31, and w41 of connection lines of the node.

For example, an l^{th} output oₗ among L output values may be represented by Equation 2 below. In this example, “L” may be an integer greater than or equal to “1” and “l” may be an integer greater than or equal to “1” and less than or equal to “L”.

oₗ=Σiₖwₖₗ Equation 2:

In Equation 2, iₖ may denote a k^{th} input among P inputs, and wₖₗ may denote a weight set between the k^{th} input and the l^{th} output. Here, “P” may be an integer greater than or equal to “1” and “k” may be an integer greater than or equal to “1” and less than or equal to “P”.

In other words, the input and output between the nodes 1015 in the neural network 1010 may be expressed as a weighted sum between the input (i) and the weight (w). The weighted sum is a multiplication operation and an iterative accumulation operation between a plurality of inputs and a plurality of weights, and may also be referred to as a “MAC operation”. Since the MAC operation is performed using a memory to which an operation function is added, a circuit on which the MAC operation is performed may be referred to as an “IMC macro”.

The neural network 1010 may, for example, perform a weighted sum operation in layers based on input data (e.g., i₁, i₂, i₃, i₄, and i₅) and generate output data (e.g., u₁, u₂, and u₃) based on a result (e.g., o₁, o₂, o₃, o₄, and o₅) of performing the operation.

The IMC macro may be a MAC operator in which the memory array 1030 is configured as a crossbar array.

The memory array 1030 may include a plurality of word lines 1031, a plurality of bit cells 1033, and a plurality of bit lines 1035.

The plurality of word lines 1031 may be used to receive input data of the neural network 1010. For example, when the plurality of word lines 1031 are N (N being an arbitrary natural number) word lines, a value corresponding to input data of the neural network 1010 may be applied to the N word lines.

The plurality of word lines 1031 may intersect with the plurality of bit lines 1035. For example, when the plurality of bit lines 1035 are M (M being an arbitrary natural number) bit lines, the plurality of bit lines 1035 and the plurality of word lines 1031 may intersect at N×M intersecting points.

In addition, the plurality of bit cells 1033 may be disposed at the intersecting points of the plurality of word lines 1031 and the plurality of bit lines 1035. Each of the plurality of bit cells 1033 may be implemented as, for example, a volatile memory, such as static random access memory (SRAM), to store weights, but is not limited thereto. Each of the plurality of bit cells 1033 may be implemented as a non-volatile memory, such as resistive random access memory (ReRAM) or eFlash.

The word lines 1031 may be referred to as “row lines” in that they correspond to horizontal rows in the memory array 1030. The bit lines 1035 may be referred to as “column lines” in that they correspond to vertical columns in the memory array 1030.

The plurality of word lines 1031 may sequentially receive a value (e.g., a second value) corresponding to input data of the neural network 1010. Here, the second value may be, for example, a value corresponding to an input signal corresponding to input data or a value corresponding to a weight. When the second value is a value corresponding to the input signal, the second value may be, for example, a binary signal of 0 or 1.

For example, when an input signal IN_1 to the IMC macro is ‘1’ or ‘high’, the input signal IN_1 may be applied to a first word line of the memory array 1030 in a first cycle corresponding to the input signal IN_1. When an input signal IN_2 to the IMC macro is ‘0’ or ‘low’, the input signal IN_2 may not be applied to a second word line of the memory array 1030 in a second cycle corresponding to the input signal IN_2.

The input signal to the IMC macro may be sequentially input to the plurality of word lines 1031 of the memory array 1030 to avoid collision of two or more input signals on the same bit line. When collision does not occur on the same bit line, the IMC macro may input two or more input signals to the word lines 1031 at the same time.

The plurality of bit cells 1033 of the memory array 1030 may be disposed at an intersecting point of a word line corresponding to a corresponding bit cell and a corresponding bit line. Each of the plurality of bit cells 1033 may store a first value corresponding to one bit. The first value may be, for example, a value corresponding to a weight (w) or a value corresponding to an input signal.

The weight (w) may be, for example, a binary signal of 0 or 1. The plurality of bit cells 1033 may or may not be disposed at the intersecting point of the corresponding word line and the corresponding bit line, according to the weight corresponding to the corresponding bit cell. For example, when a weight corresponding to a bit cell (i, j) is ‘1’, the bit cell (i, j) may be disposed at an intersecting point of the corresponding word line i and the corresponding bit line j, and an input signal input to the corresponding word line may be transferred to the corresponding bit line. In another example, when a weight corresponding to a bit cell (i+1, j+1) is ‘0’, the bit cell (i+1, j+1) is not disposed at an intersecting point of the corresponding word line (i+1) and the corresponding bit line (j+1), so even if the input signal is applied to the corresponding word line, the input signal may not be transferred to the corresponding bit line.

In the example shown in FIG. 10, since the weight corresponding to the bit cell (1, 1) corresponding to the first word line and the first bit line is ‘1’, the bit cell may be disposed at the intersecting point of the first word line and the first bit line. In this example, the input signal IN_1 input to the first word line may be transferred to the first bit line.

Alternatively, since the weight corresponding to the bit cell (1, 3) corresponding to the first word line and the third bit line is ‘0’, the bit cell may not be disposed at the intersecting point of the first word line and the third bit line. In this example, the input signal IN_1 input to the first word line may not be transferred to the third bit line.

The bit cells 1033 may also be referred to as “memory cells”. The bit cells 1033 may include, for example, any one or any combination of a diode, a transistor (e.g., a metal-oxide-semiconductor field-effect transistor (MOSFET)), an SRAM bit cell, and a resistive memory.

Hereinafter, an example in which the bit cells 1033 are SRAM bit cells will be described, but the example is not limited thereto.

The plurality of bit lines 1035 may intersect with the plurality of word lines 1031, and each of the bit lines 1035 may output a value transferred from a corresponding input line through a corresponding bit cell.

Among the plurality of bit cells 1033, bit cells disposed along the same word line may receive the same input signal and bit cells disposed along the same bit line may transfer the same output signal.

Considering the bit cells 1033 disposed in the memory array 1030 as illustrated in the example of FIG. 10, the IMC macro may perform a MAC operation as shown in Equation 3 below.

$$[ \begin{matrix}OUT\_ 1 \\ OUT\_ 2 \\ OUT\_ 3 \\ OUT\_ 4 \\ OUT\_ 5\end{matrix} ] - = [ \begin{matrix}1 & 0 & 1 & 0 & 1 \\ 1 & 1 & 0 & 0 & 1 \\ 0 & 0 & 1 & 0 & 0 \\ 1 & 1 & 0 & 1 & 0 \\ 0 & 1 & 0 & 0 & 0\end{matrix} ] [ \begin{matrix}IN\_ 1 \\ IN\_ 2 \\ IN\_ 3 \\ IN\_ 4 \\ IN\_ 5\end{matrix} ] \qquad Equation 3$$

A MAC operation may be implemented by performing and accumulating bit-wise multiplication operations on each of the bit cells included in the memory array 1030 of the IMC macro.

FIG. 11 illustrates an example of an IMC processor including a multi-bit accumulator. Referring to FIG. 11, an IMC processor 1100 according to an example may include an input controller 1110, an IMC device 1130 including a plurality of IMC macros 1130-1, and a post operation circuit 1150.

The input controller 1110 may sequentially input first values of multi bits to the IMC device 1130 bit by bit. The first values may correspond to, for example, input data or weight data.

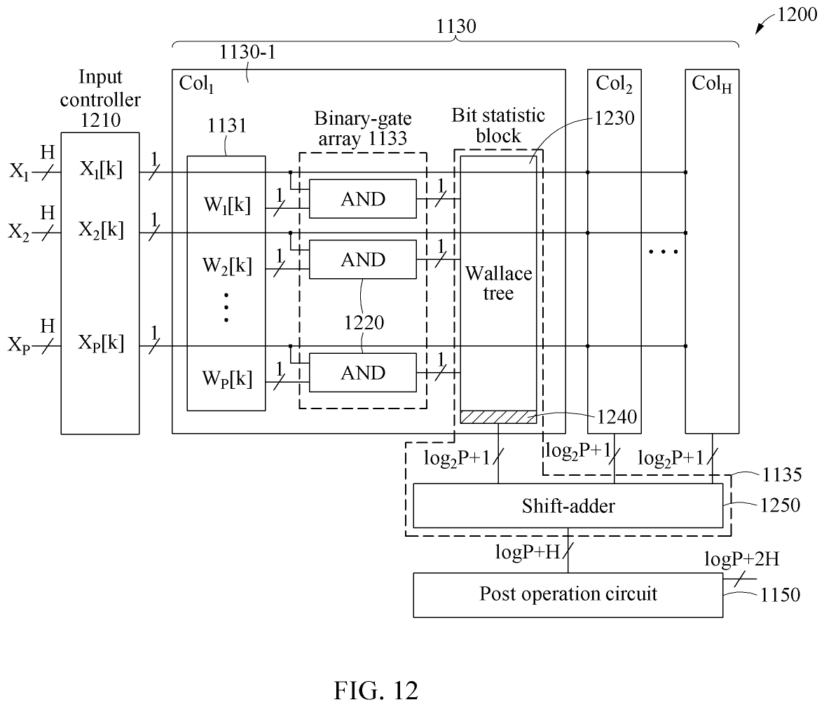

The IMC device 1130 may include, for example, the plurality of IMC macros 1130-1 including a plurality of columns Col₁, Col₂, . . . , and Col_{H} in a cross bar structure, as shown in FIG. 12 below.

Each of the IMC macros 1130-1 may include a memory array 1131, a binary gate array 1133, and a multi-bit accumulator 1135. Each of the IMC macros 1130-1 may include memory banks of the numerous memory arrays 1131.

The memory array 1131 may include bit cells that store a second value applied to each of the first values. The second values may correspond to, for example, weight data or may correspond to input data. The memory array 1131 may include a plurality of bit cells. The bit cells connected to the same bit lines of the memory array 1131 may receive the same 1-bit data.

The memory array 1131 may include a plurality of word lines, a plurality of bit lines intersecting with the plurality of word lines, and a plurality of bit cells disposed at intersecting points between the plurality of word lines and the plurality of bit lines. The memory array 1131 may include, for example, 64 word lines and 64 bit lines. In this case, the size of the memory array 1131 may be expressed as 64×64. The word lines and the column lines in the memory array 1131 may be implemented by changing one another. However, examples are not necessarily limited thereto.

The binary gate array 1133 may include operation gates that perform a single-bit binary operation between the first values and the second value or an operation gate performing an MAC operation. The operation gates may be, for example, an AND gate but are not limited thereto.

The multi-bit accumulator 1135 may perform a bit-wise operation on a single-bit binary operation result or an MAC operation result of the binary gate array 1133 and may perform an accumulation operation on an operation result corresponding to any one of columns, through a shift operation based on a clock signal.

The multi-bit accumulator 1135 may include 1-bit Wallace trees (e.g., the Wallace trees 110 of FIG. 1, FIG. 3A, FIG. 5, or FIG. 6), tristate buffers (e.g., the tristate buffers 130 of FIG. 1, FIG. 3A, FIG. 5, or FIG. 6), and a shift-adder (e.g., the shift-adder 150 of FIG. 1, 3A, 5, or 6).

The 1-bit Wallace trees may perform a bit-wise operation on single-bit MAC operation results. Each of the 1-bit Wallace trees may include an adder array including full adders used in a final operation stage among a plurality of operation stages for an add operation. The adder array may include first-type full adders where a tristate buffer connects to single-bit MAC operation results, and second-type full adders where a tristate buffer connects to a sum corresponding to an operation result of the final operation stage and to a carry operation result generated by corresponding to the sum.

The tristate buffers may output a bit-wise operation result of the 1-bit Wallace trees, according to an enable signal. When the enable signal has a first logical value (e.g., 0), the tristate buffers may output a high-impedance state and, when the enable signal has a second logical value (e.g., 1) opposite to the first logical value, the tristate buffers may output the bit-wise operation result of the 1-bit Wallace trees to the shift-adder.

The shift-adder may perform an accumulation operation on the add operation result of the 1-bit Wallace trees corresponding to any one of the columns by a shift operation, based on a clock signal.

The 1-bit Wallace trees may operate according to an enable signal having the first logical value (e.g., 0), and the shift-adder may operate according to an enable signal having a second logical value (e.g., 1) opposite to the first logical value.

The multi-bit accumulator 1135 may correspond to, for example, but is not limited to, the multi-bit accumulator illustrated in FIG. 1, FIG. 3A, FIG. 5, or FIG. 6. When the multi-bit accumulator 1135 performs, for example, a signed operation on signed data, the multi-bit accumulator 1135 may include a logic gate that performs a logical operation between the signed data and an MSB in the accumulation result. The logic gate may be, for example, an XOR gate that performs an XOR operation between the MSB and the signed data, but is not limited thereto.

The multi-bit accumulator 1135 may further include a signal generator that generates an enable signal for enabling the tristate buffer by inverting a clock signal.

The post operation circuit 1150 may output a multi-bit operation result that integrates operation results of the plurality of IMC macros 1130-1. A detailed configuration of the post operation circuit 1150 is described below with reference to FIG. 12.

FIG. 12 illustrates an example of a structure of an IMC processor. Referring to FIG. 12, an example structure of an IMC processor 1200 is illustrated.

The IMC processor 1200 may correspond to, for example, the IMC processor 1100 described above with reference to FIG. 11, but is not necessarily limited thereto.

The IMC processor 1200 includes an input controller 1210, an IMC device 1130 including a plurality of IMC macros 1130-1, and a post operation circuit 1150.

The input controller 1210 may sequentially input multi-bit first values to the IMC device 1130 bit by bit. The input controller 1210 may apply P number of H-bit first values X₁ to X_{P} to each column of the IMC device 1130. That is, the input controller 1210 may sequentially apply the P H-bit first values X₁ to X_{P} to each of the IMC macros 1130-1, one bit at a time according to time sequence. In this case, the first values may correspond to, for example, input data or weight data.

The IMC device 1130 may include, for example, a plurality of IMC macros 1130-1 including a plurality of columns Col₁, Col₂, . . . , and Col_{H} in a cross bar structure, as shown in FIG. 12.

Each of the IMC macros 1130-1 may include a memory array 1131, a binary gate array 1133, and a multi-bit accumulator 1135. Each of the IMC macros 1130-1 may include memory banks of the numerous memory arrays 1131.

The memory array 1131 may include bit cells storing P number of second values (e.g., W₁ to W_{P}) to which the number P first values (e.g., X₁ to X_{P}) apply, respectively. The second values may correspond to, for example, weight data W, or input data X. The memory array 1131 may have, for example, the same shape as the memory array 1030 of FIG. 10 but is not limited thereto.

The binary gate array 1133 may include operation gates that perform a single-bit binary operation or an MAC operation between the first values input by the input controller 1210 through a 1-bit gate and the second values stored in the memory array 1131. The operation gates may be, for example, an AND gate 1220, but are not limited thereto. The operation gates may correspond to a 1-bit multiplication operation.

The multi-bit accumulator 1135 may perform statistical processing on single-bit MAC operation results (e.g., P MAC operation results s₁ to s_{P}) output through the binary gate array 1133. Here, ‘statistical processing’ may be, for example, a count on the number of ‘1’s or the number of ‘0’s among single-bit MAC operation results s₁ to s_{P} and/or a bit-wise operation on single-bit MAC operation results s₁ to s_{P}, but is not necessarily limited thereto. The statistical processing may be performed by, for example, a 1-bit adder tree including full adders, but is not necessarily limited thereto. The 1-bit adder tree may be implemented, for example, in the form of the Wallace tree described above.

The multi-bit accumulator 1135 may include Wallace trees 1230, tristate buffers 1240, and a shift-adder 1250. Here, the Wallace trees 1230 and the tristate buffers 1240 may correspond to a bit statistic block that performs the statistical processing described above.

The shift-adder 1250 may combine operation results corresponding to any one of N columns through a shift operation and an add operation based on a clock signal. The shift-adder 1250 may correspond to, for example, the shift-adder 150 described above with reference to FIG. 1.

The shift-adder 1250 may, for example, perform a shift operation and an add operation on a bit-wise operation result (e.g., a log₂ P+1 bit) corresponding to any one of H columns. The shift-adder 1250 may output bit-wise operation results (e.g., a log₂ P+H bit) corresponding to N columns through a shift operation and an add operation. The shift-adder 1250 may be shared by each column, as shown in FIG. 12, or may be provided separately for each column.

The post operation circuit 1150 may combine outputs O1 to ON of the N columns into one and output them as a multi-bit MAC operation result. In this case, the multi-bit MAC operation result may be a log 2 P+2H bit.

The post operation circuit 1150 may, for example, receive outputs of H IMC macros 1130-1 and perform a shift operation and an accumulation. The post operation circuit 1150 may perform a shift operation on partial sums corresponding to the MAC operation results of the H IMC macros 1130-1, respectively, and accumulate the shift operation result. The post operation circuit 1150 may store, for example, an accumulation result of log₂ P+2H bits in a buffer and/or an output register but is not limited thereto.

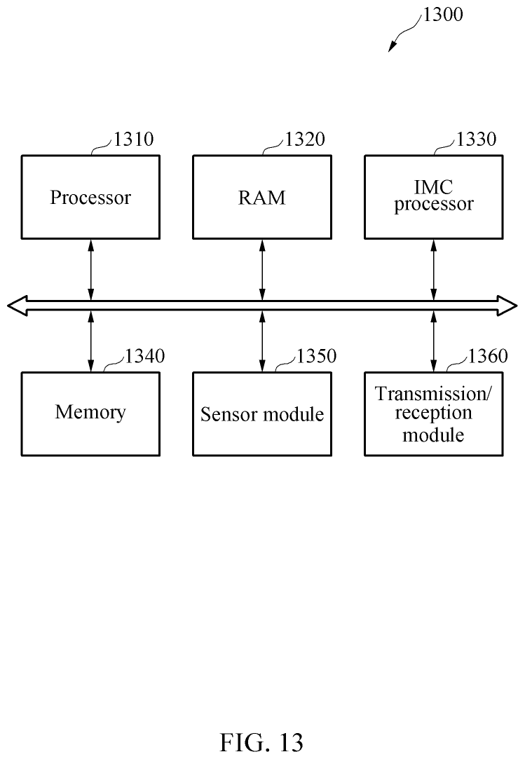

FIG. 13 illustrates an example of an electronic system including an IMC processor. Referring to FIG. 13, an electronic system 1300 may analyze input data in real time based on a neural network (e.g., the neural network 1010 of FIG. 10) and extract valid information, may determine a situation based on the extracted information, or may control components of an electronic device to which the electronic system 1300 is installed. For example, the electronic system 1300 may be a mobile device, a mobile computing device, a mobile phone, a smartphone, a personal digital assistant, a fixed location terminal, a tablet computer, a computer, a wearable device, a laptop computer, a server, a music player, a video player, an entertainment unit, a navigation device, a communication device, an Internet of Things (IoT) device, a global positioning system (GPS) device, a television, a tuner, an automobile, an automotive part, an avionics system, a drone, a multicopter, an electric vertical takeoff and landing (eVTOL) aircraft, and a medical device, and various other types of electronic devices. In another example, the IMC processor may be mounted in or on at least one of other various types of electronic devices.

The electronic system 1300 may include a processor 1310, random access memory (RAM) 1320, an IMC processor 1330, a memory 1340, a sensor module 1350, and a transmission/reception module 1360. The electronic system 1300 may further include an input/output module, a security module, a power control device, and the like. Some of the hardware components of the electronic system 1300 may be mounted on at least one semiconductor chip.

The processor 1310 may control the overall operation of the electronic system 1300. The processor 1310 may include one processor core (Single Core) or a plurality of processor cores (Multi-Core). The processor 1310 may process or execute programs and/or data stored in the memory 1340. The processor 1310 may control a function of the IMC processor 1330 by executing programs stored in the memory 1340. The processor 1310 may be implemented as a central processing unit (CPU), a graphics processing unit (GPU), an application processor (AP), and the like.

The RAM 1320 may temporarily store programs, data, or instructions. For example, the programs and/or the data stored in the memory 1340 may be temporarily stored in the RAM 1320 according to the control of the processor 1310 or booting code. The RAM 1320 may be implemented as, for example, a memory such as dynamic RAM (DRAM) or SRAM.

The IMC processor 1330 may perform an operation of a neural network (e.g., the neural network 1010 of FIG. 10), based on received input data, and generate various information signals based on an execution result. The neural network may include, for example, a convolution neural network (CNN), a recurrent neural network (RNN), a fuzzy neural network (FNN), a deep belief network, or a restricted Boltzmann machine, and the like, but is not necessarily limited thereto. The IMC processor 1330 may be, for example, a hardware accelerator dedicated to the neural network and/or a device including the neural network. The information signal may include, for example, one of various types of recognition signals, such as a speech recognition signal, an object recognition signal, a video recognition signal, and a biological information recognition signal.

The IMC processor 1330 may control SRAM-bit cell circuits of an IMC macro (e.g., the IMC macros 1130-1 in FIG. 11) to share and/or process the same input data and select at least some of operation results output from the SRAM-bit cell circuits.

The IMC processor 1330 may be, for example, but not necessarily, the IMC processor 1200 of FIG. 12.

For example, the IMC processor 1330 may receive or store, as input data, frame data included in a video stream and may generate a recognition signal about an object included in an image represented by the frame data from the frame data. Alternatively, the IMC processor 1330 may receive various types of input data and generate a recognition signal according to the input data, based on a type or a function of the electronic system 1300 on which the IMC processor 1330 is mounted.

The memory 1340 refers to a storage configured to store data and may store an operating system (OS), various types of programs, and various types of data. In an example, the memory 1340 may store intermediate results generated during an operation of the IMC processor 1330.

The memory 1340 may include any one or any combination of a volatile memory and a non-volatile memory. The non-volatile memory may include, for example, Read Only Memory (ROM), Programmable Read Only Memory (PROM), Erasable Programmable Read Only Memory (EPROM), Electrically Erasable Programmable Read Only Memory (EEPROM), flash memory, Magnetic RAM (MRAM), Phase Change Memory RAM (PRAM), Resistive RAM (RRAM), and/or Ferroelectric RAM (FRAM), but is not necessarily limited thereto. The volatile memory may include, for example, DRAM, SRAM, SDRAM, and the like, but is not necessarily limited thereto. Depending on examples, the memory 1340 may include any one or any combination of a hard disk drive (HDD), a solid state drive (SSD), a compact flash (CF) card, a secure digital (SD) card, a micro-SD card, a Mini-SD card, an extreme digital (Xd) picture card, and a memory stick.

The sensor module 1350 may collect information around the electronic device to which the electronic system 1300 is installed. The sensor module 1350 may sense or receive a signal (e.g., an image signal, a speech signal, a magnetic signal, a bio signal, a touch signal, and the like) from the outside of the electronic system 1300 and convert the sensed or received signal into data. The sensor module 1350 may include any one or any combination of various sensing devices, such as a microphone, an imaging device, an image sensor, a light detection and ranging (LIDAR) sensor, an ultrasonic sensor, an infrared sensor, a biosensor, and a touch sensor.

The sensor module 1350 may provide converted data as input data to the IMC processor 1330. For example, the sensor module 1350 may include an image sensor, generate a video stream by capturing an external environment of the electronic system, and provide successive data frames of the video stream as input data to the IMC processor 1330. However, the sensor module 1350 may not be limited thereto and may provide various types of data to the IMC processor 1330.

The transmission/reception module 1360 may include various types of wired or wireless interfaces capable of communicating with an external apparatus. For example, the transmission/reception module 1360 may include a wired local area network (LAN), a wireless local area network (WLAN) such as wireless fidelity (Wi-Fi), a wireless personal area network (WPAN) such as Bluetooth, a wireless universal serial bus (USB), ZigBee, near field communication (NFC), radio-frequency identification (RFID), power line communication (PLC), a communication interface accessible to a mobile cellular network, such as 3rd Generation (3G), 4th Generation (4G), and Long Term Evolution (LTE), and the like.

The [symbol] , and other devices, and other components described herein are implemented as, and by, hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application, and illustrated in FIGS. 1-13, are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that be performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), EEPROM, RAM, DRAM, SRAM, flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors and computers so that the one or more processors and computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An apparatus, the apparatus comprising:
a multi-bit accumulator, including:
a plurality of 1-bit Wallace trees each configured to perform an add operation on single-bit input data;
a plurality of tristate buffers configured to output a result of the add operation of the plurality of 1-bit Wallace trees, according to an enable signal; and
a shift-adder configured to perform an accumulation operation on the result of the add operation of the plurality of 1-bit Wallace trees by a shift operation based on a clock signal.

2. The apparatus of claim 1, wherein each of the plurality of 1-bit Wallace trees comprises adder arrays comprising full adders, the full adders being used in a final operation stage among a plurality of operation stages for the add operation,
wherein the adder array comprises:
first-type full adders in which a first tristate buffer of the plurality of tristate buffers is connected to a first sum among pieces of the single-bit input data; and
a second-type full adder in which a second tristate buffer of the plurality of tristate buffers is connected to a second sum, the second sum corresponding to an operation result of the final operation stage and to a carry operation result generated by corresponding to the first sum.

3. The apparatus of claim 2, wherein each of the plurality of tristate buffers are configured to:
output a high-impedance state responsive to the enable signal having a first logical value; and
output the result of the add operation of the plurality of 1-bit Wallace trees to the shift-adder responsive to the enable signal having a second logical value opposite to the first logical value.

4. The apparatus of claim 1, further comprising a logic gate configured to perform a logical operation between signed data and a most significant bit (MSB) in a result of the accumulation operation of the shift-adder responsive to the multi-bit accumulator performing a signed operation on the single-bit input data.

5. The apparatus of claim 4, wherein the logic gate comprises an XOR gate configured to perform an XOR operation between the MSB and the signed data.

6. The apparatus of claim 1, further comprising a signal generator configured to generate the enable signal that enables the tristate buffer by inverting the clock signal.

7. The apparatus of claim 1, wherein the plurality of 1-bit Wallace trees are configured to operate according to an enable signal having a first logical value, and
wherein the shift-adder is configured to operate in accordance with an enable signal having a second logical value opposite to the first logical value.

8. The apparatus of claim 1, further comprising an in memory computing (IMC) processor, wherein the IMC processor comprises a cross-bar structure, input circuitry to sequentially input multi-bit first values, output circuit to output a multi-bit operation result, a memory array, a binary gate array, and the multi-bit accumulator.

9. An apparatus, the apparatus comprising:
an in memory computing (IMC) processor, including:
an IMC device comprising a plurality of IMC macros comprising a plurality of columns in a cross bar structure;
an input controller configured to sequentially input multi-bit first values to the IMC device bit by bit; and
a post operation circuit configured to output a multi-bit operation result that integrates operation results of the plurality of IMC macros,
wherein each of the IMC macros comprises:
a memory array comprising a plurality of bit cells, each bit cell of the plurality of bit cells being configured to store a second value applied to each of the multi-bit first values;
a binary gate array comprising operation a plurality of gates, each gate of the plurality of gates being configured to perform a single-bit multiplication and accumulation (MAC) operation between the multi-bit first values and the second value; and
a multi-bit accumulator configured to perform a bit-wise operation on results of the single-bit MAC operation and to perform an accumulation operation on a result of the bit-wise operation corresponding to any one of the plurality of columns, through a shift operation based on a clock signal.

10. The apparatus of claim 9, wherein the multi-bit accumulator comprises:
a plurality of 1-bit Wallace trees, each 1-bit Wallace tree of the plurality of 1-bit Wallace trees being configured to perform the bit-wise operation on the results of the single-bit MAC operation;
a plurality of tristate buffers, each tristate buffer of the plurality of tristate buffers being configured to output a result of the bit-wise operation of a respective one of the plurality of 1-bit Wallace trees, according to an enable signal; and
a shift-adder configured to perform an accumulation operation on a result of an add operation of a respective one of the plurality of 1-bit Wallace trees corresponding to any one of the plurality of columns by a shift operation based on a clock signal.

11. The apparatus of claim 10, wherein each 1-bit Wallace tree of the plurality of 1-bit Wallace trees comprises an adder array comprising full adders used in a final operation stage among a plurality of operation stages for the add operation, wherein the adder array comprises:
a plurality of first-type full adders in which a respective tristate buffer of the plurality of tri-state buffers is connected to the results of the single-bit MAC operation; and
a second-type full adder in which a respective tristate buffer of the plurality of tri-state buffers is connected to a sum corresponding to an operation result of the final operation stage and to a carry operation result generated by corresponding to the sum.

12. The apparatus of claim 10, wherein the plurality of tristate buffers are each configured to:
output a high-impedance state responsive to the enable signal having a first logical value; and
output the result of the bit-wise operation of the plurality of 1-bit Wallace trees to the shift-adder responsive to the enable signal having a second logical value opposite to the first logical value.

13. The apparatus of claim 10, further comprising a logic gate configured to perform a logical operation between signed data and a most significant bit (MSB) in a result of the accumulation operation of the shift-adder responsive to the multi-bit accumulator performing a signed operation on the signed data.

14. The apparatus of claim 13, wherein the logic gate comprises an XOR gate configured to perform an XOR operation between the MSB and the signed data.

15. The apparatus of claim 10, further comprising a signal generator configured to generate the enable signal by inverting the clock signal.

16. The apparatus of claim 10, wherein the plurality of 1-bit Wallace trees are configured to operate responsive to the enable signal having a first logical value, and
wherein the shift-adder is configured to operate responsive to the enable signal having a second logical value opposite to the first logical value.

17. The apparatus of claim 9, wherein the apparatus is one of a mobile device, a mobile computing device, a mobile phone, a smartphone, a personal digital assistant, a fixed location terminal, a tablet computer, a computer, a wearable device, a laptop computer, a server, a music player, a video player, an entertainment unit, a navigation device, a communication device, a global positioning system (GPS) device, a television, a tuner, an automobile, a vehicle part, an avionics system, a drone, a multicopter, and a medical device.

18. A method, the method comprising:
receiving input data, the input data comprising single-bit data;
performing an add operation of 1-bit units on the input data;
outputting a result of the add operation of the 1-bit units, based on an enable signal; and
outputting a multi-bit operation result corresponding to the input data by shifting and accumulating a result of the add operation of the 1-bit units.

19. The method of claim 17, wherein the outputting of the result of the add operation of the 1-bit units comprises:
outputting a high-impedance state responsive to the enable signal having a first logical value; and
outputting the result of the add operation of the 1-bit units to a shift-adder responsive to the enable signal having a second logical value opposite to the first logical value.

20. The method of claim 17, further comprising performing a logic operation between signed data and a most significant bit (MSB) in the multi-bit operation result responsive to the multi-bit accumulator performing a signed operation on the input data.
